(19) United States
(12) Patent Application Publication
(10) Pub. No.: US 2026/0226853 A1
(43) Pub. Date: Aug. 6, 2026

(54) SYSTEM AND CONTROL METHOD

(71) Applicant: KOMATSU LTD., Tokyo (JP)

(72) Inventor: Keisuke Goma, Tokyo (JP)

(73) Assignee: KOMATSU LTD., Tokyo (JP)

(21) Appl. No.: 19/151,142

(22) PCT Filed: Jan. 30, 2024
(86) PCT No.: PCT/JP2024/002828

§ 371 Date: Jul. 25, 2025

(30) Foreign Application Priority Data
Feb. 17, 2023 (JP) 2023-023423

(51) Int. Cl. F01M 13/00; F01M 11/10; F02B 37/18

(52) U.S. Cl. CPC F01M 13/0011; F01M 11/10; F02B 37/18

(57) ABSTRACT

A system includes: a crankcase and a cylinder head of an engine operable with a fuel containing hydrogen; an engine intake passage through which air is suctioned into the engine; a crankcase intake passage branching from the engine intake passage and through which the air is introduced into the crankcase; a dilution air valve disposed in the crankcase intake passage and configured to open and close the crankcase intake passage; a compressor disposed upstream of a branch portion at which the crankcase intake passage branches from the engine intake passage; a hydrogen sensor configured to detect hydrogen concentration inside the crankcase; a communication path configured to allow an inside of the crankcase to communicate with an inside of the cylinder head; and a control device configured to control opening and closing of the dilution air valve based on the hydrogen concentration detected by the hydrogen sensor.

### TECHNICAL FIELD

The present disclosure relates to a system and a control method.

The present disclosure claims priority based on Japanese Patent Application No. 2023-023423, filed Feb. 17, 2023, the content of which is incorporated herein by reference.

### BACKGROUND ART

In an engine, gas in a combustion chamber may leak into a crankcase through a space between a cylinder and a piston. The leaking gas is called blow-by gas. Some engines can be operated with a fuel containing hydrogen. Hydrogen gas has a very wide combustible range compared to other fuels such as natural gas and gasoline, and ignites even when diluted to 10 times the theoretical air fuel ratio. Therefore, in the engine using a fuel containing hydrogen, the concentration of hydrogen gas is possibly maintained enough to be ignitable inside the crankcase. As a result, in the engine operable with a fuel containing hydrogen, hydrogen gas needs to be prevented from igniting inside the crankcase.

For example, Patent Document 1 discloses a four-stroke engine operable with a fuel containing hydrogen gas. The engine includes a crankcase in which a ventilating opening is formed, a ventilation flow path connecting the outside of the crankcase and the ventilating opening, and a ventilation fan disposed in the ventilation flow path. The ventilation fan forcibly discharges hydrogen gas in such an amount that the hydrogen gas concentration inside the crankcase is below a lower limit of the combustible range, from the inside of the crankcase to the outside together with gas other than hydrogen gas.

### CITATION LIST

### Patent Literature

Patent Document 1: JP 2021-127704 A

### SUMMARY OF INVENTION

### Technical Problem

However, a ventilation fan needs to be newly installed, which may highly cause deterioration in cost-effectiveness and reliability. Therefore, there is room for improvement in suppressing deterioration in cost-effectiveness and reliability.

The present disclosure is thus intended to provide a system and a control method that can prevent hydrogen gas from igniting inside a crankcase and suppress deterioration in cost-effectiveness and reliability.

### Solution to Problem

A system according to one aspect of the present disclosure is a system including an engine operable with a fuel containing hydrogen. The system includes: a crankcase and a cylinder head of the engine; an engine intake passage through which air is suctioned into the engine; a crankcase intake passage branching from the engine intake passage and through which the air is introduced into the crankcase; a dilution air valve disposed in the crankcase intake passage and configured to open and close the crankcase intake passage; a decompression valve disposed downstream of the dilution air valve in the crankcase intake passage; a compressor disposed upstream of a branch portion at which the crankcase intake passage branches from the engine intake passage; a hydrogen sensor configured to detect hydrogen concentration inside the crankcase; a communication path configured to allow an inside of the crankcase to communicate with an inside of the cylinder head; and a control device configured to control opening and closing of the dilution air valve based on the hydrogen concentration detected by the hydrogen sensor.

### Advantageous Effects of Invention

According to the above aspect, hydrogen gas can be prevented from igniting inside the crankcase and deterioration in cost-effectiveness and reliability can be suppressed.

### BRIEF DESCRIPTION OF DRAWINGS

FIG. 1 is a schematic configuration diagram of a system according to a first embodiment.

FIG. 2 is a flowchart of an example of a control method for the system according to the first embodiment.

FIG. 3 is a schematic configuration diagram of a system according to a second embodiment.

FIG. 4 is a schematic configuration diagram of a system according to a third embodiment.

FIG. 5 is a flowchart of an example of a control method for the system according to the third embodiment.

FIG. 6 is a schematic configuration diagram of a system according to a fourth embodiment.

FIG. 7 is a flowchart of an example of a control method for the system according to the fourth embodiment.

### DESCRIPTION OF EMBODIMENTS

Hereinafter, embodiments of the present disclosure will be described with reference to the drawings. In the embodiments, a hydrogen engine (an example of an engine operable with a fuel containing hydrogen) will be described as an engine constituting the system.

### First Embodiment

### System

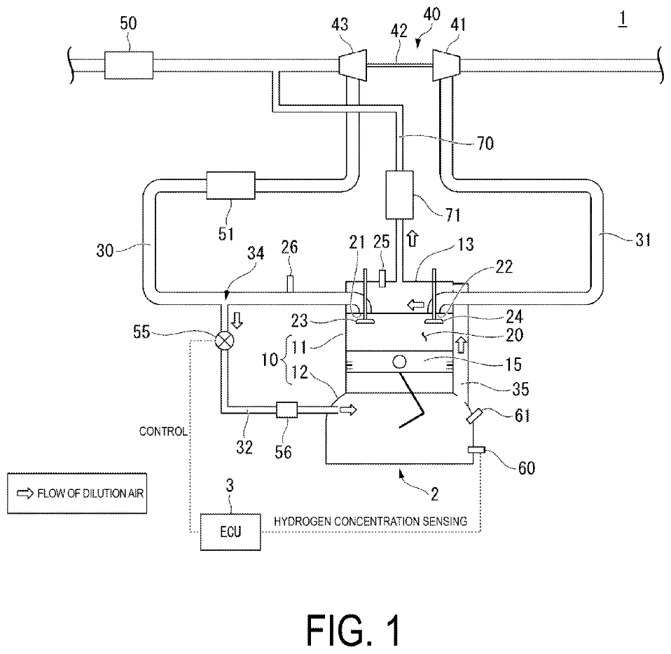

FIG. 1 is a schematic configuration diagram of a system 1 according to a first embodiment.

As illustrated in FIG. 1, the system 1 includes a hydrogen engine 2 (hereinafter, also simply referred to as “engine 2”). For example, the engine 2 may be operable with a fuel containing hydrogen and may be operable with a fuel not containing hydrogen. Note that the fuel containing hydrogen includes a fuel in which a part of the fuel is hydrogen gas and a fuel in which the entire fuel is hydrogen gas (that is, hydrogen gas itself). The use of the engine 2 is not particularly limited, and the engine 2 may be used for driving a vehicle or the like or for power generation. For example, the use of the engine 2 can be changed according to the design specifications.

The engine 2 includes a cylinder block 10 including a cylinder 11 and a crankcase 12, a cylinder head 13 located above the cylinder block 10, and a piston 15 configured to reciprocate inside the cylinder 11 and drive a crankshaft (not illustrated) via a connecting rod 14.

The engine 2 includes a combustion chamber 20 defined by an inner peripheral surface of the cylinder 11, an upper surface of the piston 15, and a lower surface of the cylinder head 13. In the cylinder head 13, an intake port 21 and an exhaust port 22 that open to the combustion chamber 20 are formed. The cylinder head 13 is provided with an intake valve 23 configured to open and close a portion of the intake port 21, which opens to the combustion chamber 20; and an exhaust valve 24 configured to open and close a portion of the exhaust port 22, which opens to the combustion chamber 20. The cylinder head 13 may be provided with an ignition device 25 configured to ignite a fuel in the combustion chamber 20.

The engine 2 may be provided with a hydrogen injection device 26 configured to inject hydrogen as the fuel into the combustion chamber 20. In the example of the drawing, the hydrogen injection device 26 is disposed in an engine intake passage 30, but is not limited thereto. For example, the hydrogen injection device 26 may be disposed in the cylinder head 13. The hydrogen injection device 26 may be disposed in the cylinder head 13, and a diesel or gasoline injection device may be disposed in the cylinder head 13. For example, the installation location of the hydrogen injection device 26 and combination thereof with another injection device can be changed according to the design specifications.

The system 1 includes the engine intake passage 30 through which air is sucked into the engine 2, and an engine exhaust passage 31 through which exhaust gas is discharged from the engine 2. The engine intake passage 30 is connected to the intake port 21. The engine exhaust passage 31 is connected to the exhaust port 22.

The system 1 includes a crankcase intake passage 32 that branches from the engine intake passage 30 and through which the air is introduced into the crankcase 12. The crankcase intake passage 32 is connected to a portion of the crankcase 12 on the intake port 21 side. Note that the connection location of the crankcase intake passage 32 is not limited to the above location and can be changed according to design specifications.

The system 1 includes a turbocharger 40 configured to increase density of the air sucked by the engine 2. This allows more oxygen to be fed to the combustion chamber 20, and higher combustion energy can be obtained. The turbocharger 40 includes a turbine 41 configured to rotate by receiving the flow of exhaust gas, a shaft 42 via which rotational force of the turbine 41 is transmitted, and a compressor 43 configured to take in and compress air by the rotational force transmitted via the shaft 42.

For example, the turbine 41 and the compressor 43 are coupled to each other via the shaft 42 so as to be integrally rotatable. The turbine 41 is disposed in the engine exhaust passage 31. The compressor 43 is disposed in the engine intake passage 30. The compressor 43 is disposed upstream of a branch portion 34 at which the crankcase intake passage 32 branches from the engine intake passage 30. Intake air flowing through the engine intake passage 30 is pressure fed by the compressor 43, and thus the intake air is forcibly fed into the combustion chamber 20 of the engine 2.

The engine intake passage 30 is provided with an air cleaner 50 configured to filter the intake air, the compressor 43, and an aftercooler 51 configured to lower the temperature of the intake air by heat exchange with the atmosphere, in the mentioned order from the upstream side in the intake air flow direction. In the engine intake passage 30, although not illustrated, an intake throttle configured to open and close the engine intake passage 30 may be disposed downstream of the aftercooler 51 and upstream of the branch portion 34. Note that the intake throttle functions as a throttle valve configured to variably set the passage cross-sectional area of the engine intake passage 30.

The system 1 includes a communication path 35 that allows the inside of the crankcase 12 to communicate with the inside of the cylinder head 13. For example, the communication path 35 may be a passage (for example, an oil return hole) for oil (for example, lubricating oil) flowing for driving a valve system of the cylinder head 13. In the example of the drawing, the communication path 35 extends vertically on a side part of the cylinder head 13. The communication path 35 is connected to a portion of the cylinder head 13 on the exhaust port 22 side and a portion of the crankcase 12 on the exhaust port 22 side. Note that the connection locations of the communication path 35 are not limited to the above locations and can be changed according to design specifications.

The system 1 includes a dilution air valve 55 disposed in the crankcase intake passage 32 and configured to open and close the crankcase intake passage 32. The dilution air valve 55 functions as a throttle valve configured to variably set the passage cross-sectional area of the crankcase intake passage 32.

The system 1 includes a decompression valve 56 configured to reduce pressure of the intake air flowing through the crankcase intake passage 32 to a predetermined pressure or lower. The decompression valve 56 is disposed downstream of the dilution air valve 55 in the crankcase intake passage 32. The dilution air valve 55 and the decompression valve 56 are disposed in the crankcase intake passage 32 in the mentioned order from the upstream side in the intake air flow direction.

The system 1 includes a hydrogen sensor 60 configured to detect hydrogen concentration inside the crankcase 12. In the example of the drawing, the hydrogen sensor 60 is disposed near a lower part of a portion of the crankcase 12 on the exhaust port 22 side. Note that the installation location of the hydrogen sensor 60 is not limited to the above location and can be changed according to the design specifications.

The engine 2 repeats a cycle of an intake process, a compression process, a combustion expansion process, and an exhaust process. In the intake process, the combustion chamber 20 is filled with a mixed gas in which intake gas and fuel are mixed. A part of the mixed gas leaks into the crankcase 12 through a space between the cylinder 11 and the piston 15 mainly in the compression process and the combustion expansion process. When the fuel containing hydrogen is used, hydrogen gas enters the crankcase 12. The hydrogen sensor 60 detects the concentration of the hydrogen gas that has entered (hydrogen concentration inside the crankcase 12). A detection signal of the hydrogen sensor 60 (the detected hydrogen concentration) is sent to a control device 3 (ECU in the drawing).

The system 1 includes the control device 3 configured to control opening and closing of the dilution air valve 55 based on the hydrogen concentration detected by the hydrogen sensor 60. When the hydrogen concentration detected by the hydrogen sensor 60 reaches a threshold value or higher, the control device 3 performs control to open the dilution air valve 55 to a predetermined degree or more. Note that the control device 3 may integrally control the components of the system 1.

The system 1 includes a pressure relief valve 61 configured to release the air inside the crankcase 12 before the pressure inside the crankcase 12 reaches a predetermined pressure or higher. In the example of the drawing, the pressure relief valve 61 is disposed near a lower part of a portion of the crankcase 12 to which the communication path 35 is connected. Note that the installation location of the pressure relief valve 61 is not limited to the above location and can be changed according to design specifications.

The system 1 includes a cylinder head communication passage 70 that allows the inside of the cylinder head 13 to communicate with the upstream side of the compressor 43 in the engine intake passage 30. In the example of the drawing, the cylinder head communication passage 70 is connected to a central portion on an upper surface of the cylinder head 13 and a portion of the engine intake passage 30 between the air cleaner 50 and the compressor 43. Note that the installation locations of the cylinder head communication passage 70 are not limited to the above locations and can be changed according to design specifications.

In the present embodiment, the communication path 35 allows the inside of the crankcase 12 to communicate with the inside of the cylinder head 13. Accordingly, the air compressed in the compressor 43 is introduced into the crankcase 12, and the flow of air can be created from the crankcase 12 toward the cylinder head 13 by the communication path 35. Additionally, in the present embodiment, the cylinder head communication passage 70 allows the inside of the cylinder head 13 to communicate with the upstream side of the compressor 43 in the engine intake passage 30. Accordingly, the flow of air from the cylinder head 13 toward the upstream side of the compressor 43 can be created. The arrows in the drawing indicate the flow of dilution air.

The system 1 includes a filter 71 disposed in the cylinder head communication passage 70. The filter 71 filters exhaust gas. For example, the filter 71 removes (collects) components contained in the exhaust gas from the inside of the cylinder head 13. The components contained in the exhaust gas include particulate matter (PM), hydrocarbons (HC), nitrogen oxides (NOx), carbon monoxide (CO), carbon dioxide (CO2), sulfur oxides (SOx), and the like. For example, the components contained in the exhaust gas include oil mist and the like.

### Example of Control Method for System

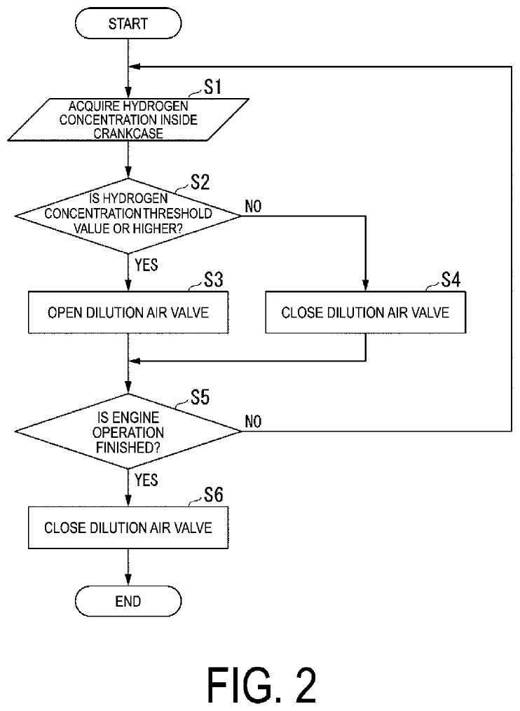

FIG. 2 is a flowchart of an example of a control method for the system 1 according to the first embodiment. The control method for the system 1 corresponds to an ignition prevention program to be executed by the control device 3.

The control method of the present embodiment includes a hydrogen concentration acquisition step (step S1) of acquiring the hydrogen concentration inside the crankcase 12, a hydrogen concentration determination step (step S2) of determining whether or not the hydrogen concentration is a threshold value or higher, a valve opening step (step S3) of opening the dilution air valve 55 when it is determined that the hydrogen concentration is the threshold value or higher, and a valve closing step (step S4) of closing the dilution air valve 55 when it is determined that the hydrogen concentration is lower than the threshold value.

Referring also to FIG. 2, first, the hydrogen concentration inside the crankcase 12 is acquired (step S1). For example, in step S1, the control device 3 acquires a detection signal of the hydrogen sensor 60 (the detected hydrogen concentration). After step S1, the program proceeds to step S2.

In step S2, the control device 3 determines whether or not the hydrogen concentration is the threshold value or higher. The threshold value is set to a lower limit value of the combustible range of hydrogen gas. Note that the threshold value may be set to a value lower than the lower limit value of hydrogen gas by a predetermined amount.

For example, the combustible range of hydrogen gas in the air is about 4 vol % or more and 75 vol % or less. Therefore, when the inside of the crankcase 12 is filled with hydrogen gas and air, the lower limit value of the variable range is 4 vol %. In this case, the threshold value is set to 4 vol %. Note that the threshold value may be set with a certain margin to a value (for example, 3 vol %) lower than 4 vol %.

When it is determined that the hydrogen concentration is the threshold value or higher (YES in step S2), the program proceeds to step S3. When it is determined that the hydrogen concentration is the threshold value or higher, hydrogen gas is likely to ignite inside the crankcase 12.

On the other hand, when it is determined that the hydrogen concentration is not the threshold value or higher (that is, when it is determined that the hydrogen concentration is lower than the threshold value) (NO in step S2), the program proceeds to step S4.

In step S3, the dilution air valve 55 is opened. For example, in step S3, the control device 3 performs control to open the dilution air valve 55 to a predetermined degree or more. After step S3, the program proceeds to step S5.

In step S4, the dilution air valve 55 is closed. For example, in step S4, the control device 3 performs control to completely close the dilution air valve 55. After step S4, the program proceeds to step S5.

In step S5, the control device 3 determines whether the operation of the engine 2 is finished. When it is determined that the operation of the engine 2 is finished (YES in step S5), the program proceeds to step S6. On the other hand, when it is determined that the operation of the engine 2 is not finished (NO in step S5), the program returns to step S1, and steps S1 to S5 are repeated until the operation of the engine 2 is finished.

In step S6, the dilution air valve 55 is closed. For example, in step S6, the control device 3 performs control to completely close the dilution air valve 55.

As described above, the flow of the control method for the system 1 ends.

### Actions and Effects

As described above, the system 1 of the present embodiment is a system 1 including the engine 2 operable with a fuel containing hydrogen. The system 1 includes the crankcase 12 and the cylinder head 13 of the engine 2, the engine intake passage 30 through which air is suctioned into the engine 2, the crankcase intake passage 32 branching from the engine intake passage 30 and through which the air is introduced into the crankcase 12, the dilution air valve 55 disposed in the crankcase intake passage 32 and configured to open and close the crankcase intake passage 32, the decompression valve 56 disposed downstream of the dilution air valve 55 in the crankcase intake passage 32, the compressor 43 disposed upstream of the branch portion 34 at which the crankcase intake passage 32 branches from the engine intake passage 30, the hydrogen sensor 60 configured to detect hydrogen concentration inside the crankcase 12, the communication path 35 configured to allow the inside of the crankcase 12 to communicate with the inside of the cylinder head 13, and the control device 3 configured to control opening and closing of the dilution air valve 55 based on the hydrogen concentration detected by the hydrogen sensor 60.

According to this configuration, the opening and closing of the dilution air valve 55 can be controlled based on the hydrogen concentration detected by the hydrogen sensor 60 while the air compressed in the compressor 43 is introduced into the crankcase 12. Accordingly, the hydrogen concentration inside the crankcase 12 can be adjusted. In addition, since the air compressed in the compressor 43 is used, a suction fan or the like is not required, and the existing engine 2 can be configured with a minimum number of additional components. Therefore, the possibility of deterioration in cost-effectiveness and reliability is low. As a result, hydrogen gas can be prevented from igniting inside the crankcase 12 and suppress deterioration in cost-effectiveness and reliability.

In addition, ventilation of blow-by gas is intermittently performed by operating the dilution air valve 55 by sensing the hydrogen concentration inside the crankcase 12. Therefore, only the minimum amount of dilution air is required.

In addition, the pressure of the intake air flowing through the crankcase intake passage 32 is reduced to a predetermined pressure or lower by the decompression valve 56 disposed downstream of the dilution air valve 55 in the crankcase intake passage 32, and thus the pressure inside the crankcase 12 can be prevented from excessively increasing. Therefore, coming-off or the like of an oil seal disposed in the crankcase 12 can be prevented.

In addition, the communication path 35 that allows the inside of the crankcase 12 to communicate with the inside of the cylinder head 13 can create the flow of air from the crankcase 12 toward the cylinder head 13. Therefore, the dilution efficiency of the blow-by gas can be improved.

In addition, since hydrogen gas is lighter than the air, hydrogen gas can smoothly flow from the inside of the crankcase 12 toward the cylinder head 13 located at an upper portion of the engine 2. Therefore, hydrogen gas can be more reliably prevented from igniting inside the crankcase 12.

In the present embodiment, the control device 3 performs control to open the dilution air valve 55 to a predetermined degree or more when the hydrogen concentration detected by the hydrogen sensor 60 reaches the threshold value or higher.

According to this configuration, the dilution air valve 55 can be opened to a predetermined degree or more when the hydrogen concentration detected by the hydrogen sensor 60 reaches the threshold value or higher while the air compressed in the compressor 43 is introduced into the crankcase 12. Accordingly, the hydrogen concentration inside the crankcase 12 can be out of the combustible range. Therefore, hydrogen gas can be more reliably prevented from igniting inside the crankcase 12.

In the present embodiment, the system 1 includes the cylinder head communication passage 70 that allows the inside of the cylinder head 13 to communicate with the upstream side of the compressor 43 in the engine intake passage 31, and the filter 71 disposed in the cylinder head communication passage 70.

According to this configuration, exhaust gas from the cylinder head communication passage 70 can be purified by the filter 71. Therefore, the compressor 43 can be prevented from being contaminated by components or the like (for example, oil mist or the like) contained in the exhaust gas.

In the present embodiment, the system 1 includes the pressure relief valve 61 configured to release the air inside the crankcase 12 before the pressure inside the crankcase 12 reaches a predetermined pressure or higher.

According to this configuration, the pressure relief valve 61 can prevent the pressure inside the crankcase 12 from excessively increasing. Therefore, coming-off or the like of an oil seal disposed in the crankcase 12 can be prevented.

In the present embodiment, the control method includes the hydrogen concentration acquisition step (step S1) of acquiring the hydrogen concentration inside the crankcase 12, the hydrogen concentration determination step (step S2) of determining whether or not the hydrogen concentration is the threshold value or higher, the valve opening step (step S3) of opening the dilution air valve 55 when it is determined that the hydrogen concentration is the threshold value or higher, and the valve closing step (step S4) of closing the dilution air valve 55 when it is determined that the hydrogen concentration is lower than the threshold value.

According to this method, hydrogen gas can be prevented from igniting inside the crankcase 12 and suppress deterioration in cost-effectiveness and reliability.

In addition, by including the valve opening step and the valve closing step, ventilation of the blow-by gas becomes intermittent. Therefore, only the minimum amount of dilution air is required.

In addition, the valve opening step enables the hydrogen concentration inside the crankcase 12 to be out of the combustible range. Therefore, hydrogen gas can be more reliably prevented from igniting inside the crankcase 12.

### Second Embodiment

In the first embodiment, the example in which the dilution air valve 55 and the decompression valve 56 are disposed in the crankcase intake passage 32 in the mentioned order from the upstream side in the intake air flow direction is illustrated. A second embodiment is different from the first embodiment in that a crankcase communication passage 282 branching from the crankcase intake passage 32 at a portion between the dilution air valve 55 and the decompression valve 56 and communicating with the inside of the crankcase 12, and other components are provided. In the following description, configurations that are the same as those of the first embodiment are denoted by the same reference signs, and description of the configurations is omitted.

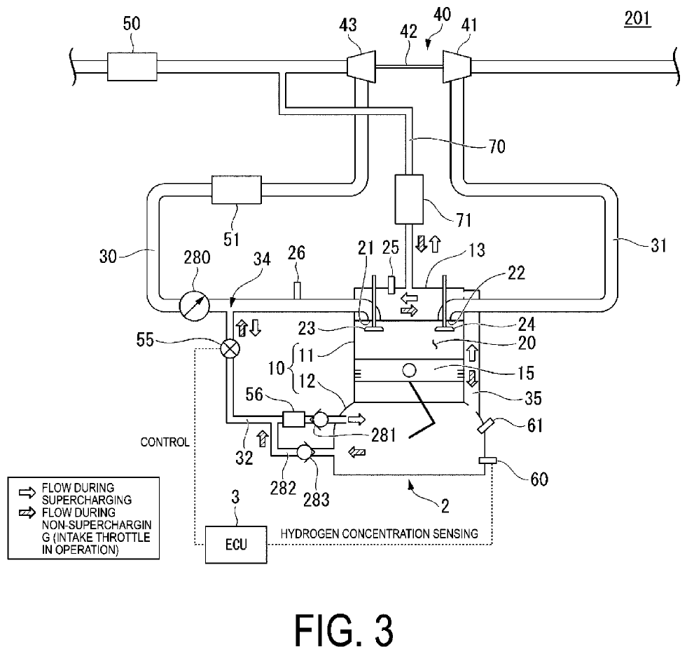

FIG. 3 is a schematic configuration diagram of a system 201 according to the second embodiment.

As illustrated in FIG. 3, the system 201 includes an intake throttle 280 disposed downstream of the compressor 43 and upstream of the branch portion in the engine intake passage 30, a first check valve 281 disposed downstream of the decompression valve 56 in the crankcase intake passage 32 and configured to allow only the flow of gas from the decompression valve 56 toward the inside of the crankcase 12, the crankcase communication passage 282 branching from the crankcase intake passage 32 at a portion between the dilution air valve 55 and the decompression valve 56 and communicating with the inside of the crankcase 12, and a second check valve 283 disposed in the crankcase communication passage 282 and configured to allow only the flow of gas from the inside of the crankcase 12 toward the crankcase intake passage 32.

The intake throttle 280 is disposed downstream of the aftercooler 51 and upstream of the branch portion 34 in the engine intake passage 30. The intake throttle 280 is a valve configured to open and close the engine intake passage 30. The intake throttle 280 functions as a throttle valve configured to variably set the passage cross-sectional area of the engine intake passage 30.

The first check valve 281 restricts the flow of gas from the inside of the crankcase 12 toward the decompression valve 56 in the crankcase intake passage 32, and allows the flow of gas from the decompression valve 56 toward the inside of the crankcase 12. For example, the first check valve 281 may be with spring (the valve is held in a closed position by the spring) or without spring. For example, the configuration mode of the first check valve 281 can be changed according to the design specifications.

In the example of the drawing, the crankcase communication passage 282 is connected to a portion of the crankcase intake passage 32 between the dilution air valve 55 and the decompression valve 56 and a location near a lower part of a portion of the crankcase 12 on the intake port 21 side (a portion to which the crankcase intake passage 32 is connected). Note that the connection locations of the crankcase communication passage 282 are not limited to the above locations and can be changed according to design specifications.

The second check valve 283 restricts the flow of gas in the crankcase communication passage 282 toward the inside of the crankcase 12, and allows the flow of gas from the inside of the crankcase 12 toward the crankcase intake passage 32. For example, the second check valve 283 may be with spring (the valve is held in a closed position by the spring) or without spring.

For example, the configuration mode of the second check valve 283 can be changed according to the design specifications.

### Flow during Supercharging

For example, during supercharging, the air-fuel mixture inside the crankcase 12 can be diluted using positive pressure of the intake air. In the example of the drawing, as indicated by the arrows of the flow during supercharging, the air compressed in the compressor 43 is introduced into the crankcase 12 through the crankcase intake passage 32 and the like, and the flow of air from the crankcase 12 toward the cylinder head 13 can be created by the communication path 35. Additionally, the flow of air can be created from the cylinder head 13 toward the upstream side of the compressor 43 through the cylinder head communication passage 70.

### Flow during Non-Supercharging

For example, during non-supercharging, even when the intake air is negative pressure, the air-fuel mixture inside the crankcase 12 can be diluted. The time during non-supercharging corresponds to a case where the intake throttle 280 is operating. When the intake throttle 280 is operated and the pressure reaches negative, the flow is reversed from the flow during supercharging. In the example of the drawing, as indicated by the arrows of the flow during non-supercharging, the flow of air can be created from the upstream side of the compressor 43 toward the cylinder head 13 through the cylinder head communication passage 70. Further, the flow of air can be created from the cylinder head 13 toward the crankcase 12 through the communication path 35. Furthermore, the flow of air can be created from the crankcase 12 toward the downstream side of the intake throttle 280 through the crankcase communication passage 282 and the like.

### Actions and Effects

In the present embodiment, the system 201 includes the intake throttle 280 disposed downstream of the compressor 43 and upstream of the branch portion in the engine intake passage 30, the first check valve 281 disposed downstream of the decompression valve 56 in the crankcase intake passage 32 and configured to allow only the flow of gas from the decompression valve 56 toward the inside of the crankcase 12, the crankcase communication passage 282 branching from the crankcase intake passage 32 at a portion between the dilution air valve 55 and the decompression valve 56 and communicating with the inside of the crankcase 12, and the second check valve 283 disposed in the crankcase communication passage 282 and configured to allow only the flow of gas from the inside of the crankcase 12 toward the crankcase intake passage 32.

According to this configuration, during supercharging, the air compressed in the compressor 43 is introduced into the crankcase 12 through the crankcase intake passage 32 and the like, and the flow of air can be created from the crankcase 12 toward the cylinder head 13 by the communication path 35. On the other hand, during non-supercharging, the flow of air can be created from the crankcase 12 toward the downstream side of the intake throttle 280 through the crankcase communication passage 282 and the like. Therefore, the air-fuel mixture inside the crankcase 12 can be diluted by the positive pressure or the negative pressure of the intake air.

### Third Embodiment

In the first embodiment, the example in which the filter 71 is disposed in the cylinder head communication passage 70 is described. A third embodiment is different from the first embodiment in that a cylinder head exhaust passage 390 branching from the cylinder head communication passage 70 and through which the air inside the cylinder head 13 is discharged, and other components are provided. In the following description, configurations that are the same as those of the first embodiment and the second embodiment are denoted by the same reference signs, and description of the configurations is omitted.

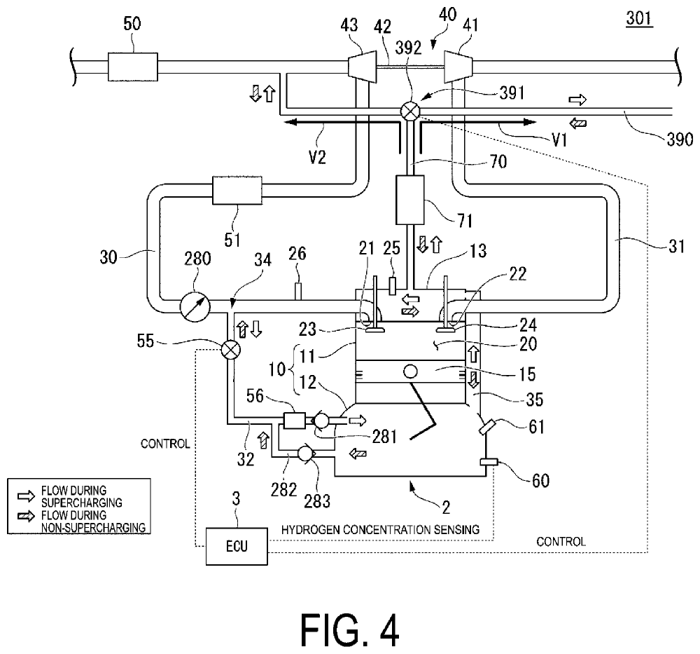

FIG. 4 is a schematic configuration diagram of a system 301 according to the third embodiment.

As illustrated in FIG. 4, the system 301 includes the cylinder head exhaust passage 390 branching from the cylinder head communication passage 70 and through which the air inside the cylinder head 13 is discharged, and a switching valve 392 disposed at a branch portion 391 at which the cylinder head exhaust passage 390 branches from the cylinder head communication passage 70 and configured to switch between a first path V1 through which the cylinder head exhaust passage 390 is exposed to the atmosphere and a second path V2 through which the cylinder head communication passage 70 connects to the upstream side of the compressor 43.

The control device 3 controls the switching valve 392 to switch to the second path V2 when the hydrogen concentration detected by the hydrogen sensor 60 reaches the threshold value or higher. The control device 3 controls the switching valve 392 to switch to the first path V1 when the hydrogen concentration detected by the hydrogen sensor 60 is not the threshold value or higher (that is, when the hydrogen concentration is lower than the threshold value).

### Example of Control Method for System

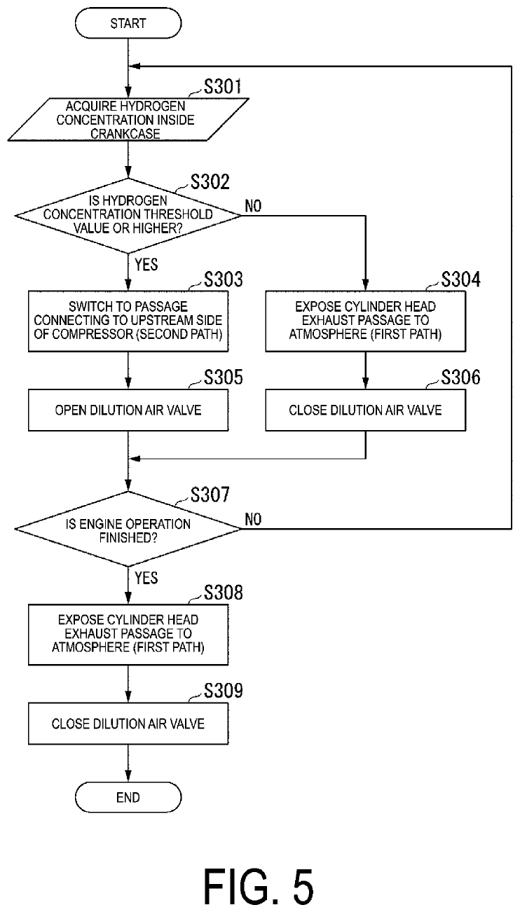

FIG. 5 is a flowchart of an example of a control method for the system 301 according to the third embodiment. The control method for the system 301 corresponds to an ignition prevention program to be executed by the control device 3.

The control method of the present embodiment includes a second path switching step (step S303) of allowing the switching valve 392 to switch to the second path V2 when it is determined that the hydrogen concentration is the threshold value or higher, and a first path switching step (step S304) of allowing the switching valve 392 to switch to the first path V1 when it is determined that the hydrogen concentration is lower than the threshold value.

Referring also to FIG. 5, first, the hydrogen concentration inside the crankcase 12 is acquired (step S301). For example, in step S301, the control device 3 acquires a detection signal of the hydrogen sensor 60 (the detected hydrogen concentration). After step S301, the program proceeds to step S302.

In step S302, the control device 3 determines whether or not the hydrogen concentration is the threshold value or higher. The threshold value is set to the lower limit (for example, 4 vol %) of the combustible range of hydrogen gas. Note that the threshold value may be set to a value (for example, 3 vol %) lower than the lower limit of hydrogen gas by a predetermined amount.

When it is determined that the hydrogen concentration is the threshold value or higher (YES in step S302), the program proceeds to step S303. On the other hand, when it is determined that the hydrogen concentration is not the threshold value or higher (that is, when it is determined that the hydrogen concentration is lower than the threshold value) (NO in step S303), the program proceeds to step S304.

In step S303, the passage is switched so that the cylinder head communication passage 70 connects to the upstream side of the compressor 43 (the second path V2). For example, in step S303, the control device 3 controls the switching valve 392 to switch to the second path V2. As a result, the inside of the cylinder head 13 connects to the upstream side of the compressor 43 in the engine intake passage 30. After step S303, the program proceeds to step S305.

In step S305, the dilution air valve 55 is opened. For example, in step S305, the control device 3 performs control to open the dilution air valve 55 to a predetermined degree or more. After step S305, the program proceeds to step S307.

On the other hand, in step S304, the cylinder head exhaust passage 390 is exposed to the atmosphere (the first path V1). For example, in step S304, the control device 3 controls the switching valve 392 to switch to the first path V1. After step S304, the program proceeds to step S306.

In step S306, the dilution air valve 55 is closed. For example, in step S306, the control device 3 performs control to completely close the dilution air valve 55. After step S306, the program proceeds to step S307.

In step S307, the control device 3 determines whether the operation of the engine 2 is finished. When it is determined that the operation of the engine 2 is finished (YES in step S307), the program proceeds to step S308. On the other hand, when it is determined that the operation of the engine 2 is not finished (NO in step S307), the program returns to step S301, and steps S301 to S307 are repeated until the operation of the engine 2 is finished.

In step S308, the cylinder head exhaust passage 390 is exposed to the atmosphere (the first path V1). After step S308, the program proceeds to step S309.

In step S309, the dilution air valve 55 is closed. For example, in step S309, the control device 3 performs control to completely close the dilution air valve 55.

As described above, the flow of the control method for the system 301 ends.

### Actions and Effects

In the present embodiment, the system 301 includes the cylinder head exhaust passage 390 branching from the cylinder head communication passage 70 and through which the air inside the cylinder head 13 is discharged, and the switching valve 392 disposed at the branch portion 391 at which the cylinder head exhaust passage 390 branches from the cylinder head communication passage 70 and configured to switch between the first path V1 through which the cylinder head exhaust passage 390 is exposed to the atmosphere and the second path V2 through which the cylinder head communication passage 70 connects to the upstream side of the compressor 43.

According to this configuration, the switching valve 392 can select whether to release the dilution air discharged from the cylinder head 13 to the atmosphere (switching to the first path V1) or to return the dilution air to the upstream side of the compressor 43 (switching to the second path V2). Therefore, at the time of switching to the second path V2, the exhaust gas from the cylinder head exhaust passage 390 does not flow to the outside. As a result, deterioration of exhaust gas emission can be minimized.

On the other hand, at the time of switching to the first path V2, the exhaust gas from the cylinder head 13 does not flow to the upstream side of the compressor 43. Therefore, the compressor 43 can be prevented from being contaminated by components or the like (for example, oil mist or the like) contained in the exhaust gas. For example, when the filter 71 is disposed in the cylinder head communication passage 70, durability and reliability of the compressor 43 can be further improved in combination with cleaning by the filter 71.

In the present embodiment, the control device 3 controls the switching valve 392 to switch to the second path V2 when the hydrogen concentration detected by the hydrogen sensor 60 reaches the threshold value or higher.

According to this configuration, when the hydrogen concentration detected by the hydrogen sensor 60 reaches the threshold value or higher, the air from the cylinder head communication passage 70 (the second path V2) is compressed in the compressor 43, and the compressed air can be introduced into the crankcase 12. Therefore, when the hydrogen concentration detected by the hydrogen sensor 60 reaches the threshold value or higher, the exhaust gas from the cylinder head exhaust passage 390 does not flow to the outside. As a result, deterioration of exhaust gas emission can be minimized.

In the present embodiment, the control method includes the second path switching step (step S303) of allowing the switching valve 392 to switch to the second path V2 when it is determined that the hydrogen concentration is the threshold value or higher, and the first path switching step (step S304) of allowing the switching valve 392 to switch to the first path V1 when it is determined that the hydrogen concentration is lower than the threshold value.

According to this method, by the second path switching step, the exhaust gas from the cylinder head exhaust passage 390 does not flow to the outside. As a result, deterioration of exhaust gas emission can be minimized.

On the other hand, by the first path switching step, the exhaust gas from the cylinder head 13 does not flow to the upstream side of the compressor 43. Therefore, the compressor 43 can be prevented from being contaminated by components or the like (for example, oil mist or the like) contained in the exhaust gas.

### Fourth Embodiment

In the first embodiment, the example in which the hydrogen sensor 60 is disposed in the crankcase 12 is described. A fourth embodiment is different from the first embodiment in that the hydrogen sensor 60 is disposed downstream of the filter 71 in the cylinder head communication passage 70. In the following description, configurations that are the same as those of the first embodiment are denoted by the same reference signs, and description of the configurations is omitted.

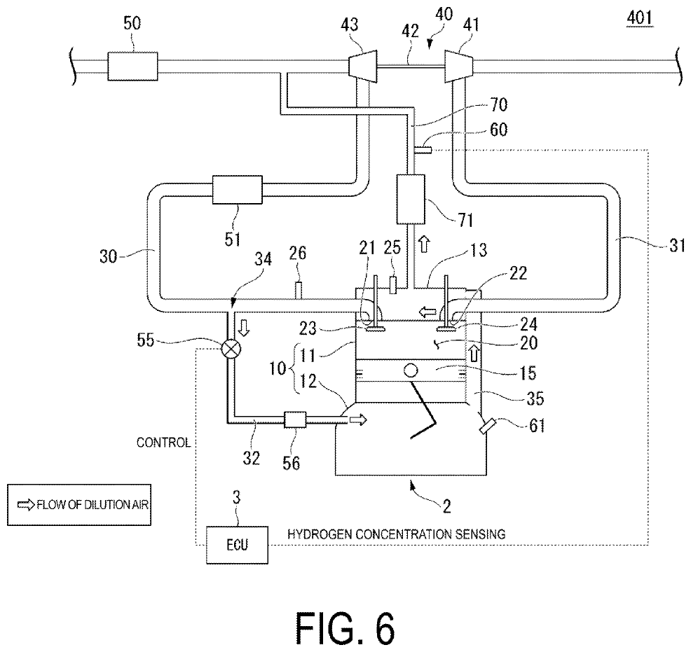

FIG. 6 is a schematic configuration diagram of a system 401 according to the fourth embodiment.

As illustrated in FIG. 6, the system 401 includes the hydrogen sensor 60 configured to detect the hydrogen concentration inside the crankcase 12 in the cylinder head communication passage 70. In the example of the drawing, the hydrogen sensor 60 is disposed closer to the position at which the filter 71 is disposed (near the downstream side of the filter 71) than a portion connected to the upstream side of the compressor 43 in the cylinder head communication passage 70. Note that the installation location of the hydrogen sensor 60 is not limited to the above location and can be changed according to the design specifications.

### Example of Control Method for System

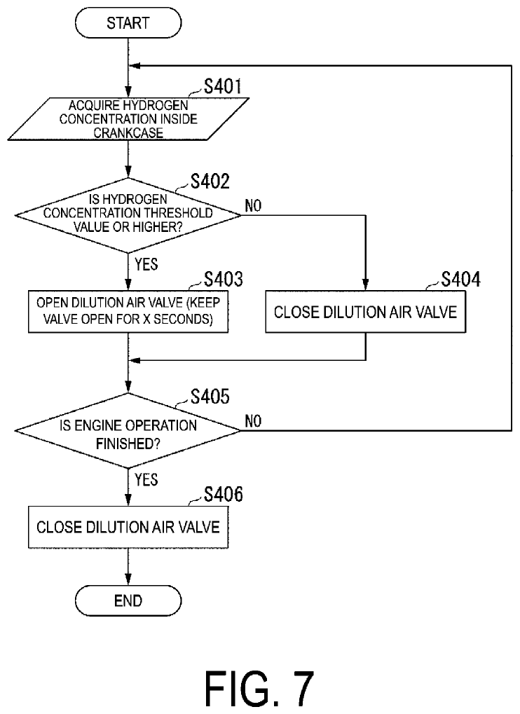

FIG. 7 is a flowchart of an example of a control method for the system 401 according to the fourth embodiment. The control method for the system 401 corresponds to an ignition prevention program to be executed by the control device 3.

The control method of the present embodiment is the same as the control method of the first embodiment except for a valve opening step (step S403) of opening the dilution air valve 55 when it is determined that the hydrogen concentration is the threshold value or higher. Steps S401, S402, S404, S405, and S406 of the present embodiment are the same as steps S1, S2, S4, S5, and S6 of the first embodiment, respectively, and thus detailed description thereof will be omitted.

Referring also to FIG. 7, when it is determined that the hydrogen concentration is the threshold value or higher (YES in step S402), the program proceeds to step S403. On the other hand, when it is determined that the hydrogen concentration is not the threshold value or higher (that is, when it is determined that the hydrogen concentration is lower than the threshold value) (NO in step S403), the program proceeds to step S404.

In step S403, the dilution air valve 55 is opened and kept open for a predetermined time (for example, X seconds). For example, in step S403, the control device 3 performs control to open the dilution air valve 55 to a predetermined degree or more and keep the valve open for only several seconds. After hydrogen step S403, the program proceeds to step S405.

After step S405, the same control as that of the first embodiment described above is performed.

As described above, the flow of the control method for the system 401 ends.

### Actions and Effects

In the present embodiment, the hydrogen sensor 60 is disposed downstream of the filter 71 in the cylinder head communication passage 70.

According to this configuration, the hydrogen sensor 60 can be prevented from being contaminated by components or the like (for example, oil mist or the like) contained in the exhaust gas. For example, compared to a case where the hydrogen sensor 60 is disposed in the crankcase 12, durability and reliability of the hydrogen sensor 60 can be further improved.

### Modification Example

In the embodiment described above, the example is described in which the system further includes the cylinder head communication passage configured to allow the inside of the cylinder head to communicate with the upstream side of the compressor in the engine intake passage, and the filter disposed in the cylinder head communication passage, but the present disclosure is not limited thereto. For example, the system need not include a filter. For example, the installation mode of the filter can be changed according to the design specifications.

In the embodiment described above, the example is described in which the system further includes the pressure relief valve configured to release the air inside the crankcase before the pressure inside the crankcase reaches a predetermined pressure or higher, but the present disclosure is not limited thereto. For example, the system need not include a pressure relief valve. For example, the installation mode of the pressure relief valve can be changed according to the design specifications.

Although the embodiments of the present disclosure are described above, the present disclosure is not limited to these, and additions, omissions, substitutions, and other modifications of the configuration are possible without departing from the spirit of the present disclosure, and the embodiments described above can also be combined as appropriate.

### Supplementary Note 1

A system including an engine operable with a fuel containing hydrogen, the system including:
a crankcase and a cylinder head of the engine;
an engine intake passage through which air is suctioned into the engine;
a crankcase intake passage branching from the engine intake passage and through which the air is introduced into the crankcase;
a dilution air valve disposed in the crankcase intake passage and configured to open and close the crankcase intake passage;
a decompression valve disposed downstream of the dilution air valve in the crankcase intake passage;
a compressor disposed upstream of a branch portion at which the crankcase intake passage branches from the engine intake passage;
a hydrogen sensor configured to detect hydrogen concentration inside the crankcase;
a communication path configured to allow an inside of the crankcase to communicate with an inside of the cylinder head; and
a control device configured to control opening and closing of the dilution air valve based on the hydrogen concentration detected by the hydrogen sensor.

### Supplementary Note 2

The system according to Supplementary Note 1, wherein when the hydrogen concentration detected by the hydrogen sensor reaches a threshold value or higher, the control device performs control to open the dilution air valve to a predetermined degree or more.

### Supplementary Note 3

The system according to Supplementary Note 1 or 2, further including:
an intake throttle disposed downstream of the compressor and upstream of the branch portion in the engine intake passage;
a first check valve disposed downstream of the decompression valve in the crankcase intake passage and configured to allow only a flow of gas from the decompression valve toward the inside of the crankcase;
a crankcase communication passage branching from the crankcase intake passage at a portion between the dilution air valve and the decompression valve and communicating with the inside of the crankcase; and
a second check valve disposed in the crankcase communication passage and configured to allow only a flow of gas from the inside of the crankcase toward the crankcase intake passage.

### Supplementary Note 4

The system according to any one of Supplementary Notes 1 to 3, further including:
a cylinder head communication passage configured to allow the inside of the cylinder head to communicate with an upstream side of the compressor in the engine intake passage;
a cylinder head exhaust passage branching from the cylinder head communication passage and through which the air inside the cylinder head is discharged; and
a switching valve disposed at a branch portion at which the cylinder head exhaust passage branches from the cylinder head communication passage and configured to switch between a first path through which the cylinder head exhaust passage is exposed to the atmosphere and a second path through which the cylinder head communication passage connects to the upstream side of the compressor.

### Supplementary Note 5

The system according to Supplementary Note 4, wherein the control device is configured to control the switching valve to switch to the second path when the hydrogen concentration detected by the hydrogen sensor reaches a threshold value or higher.

### Supplementary Note 6

The system according to any one of Supplementary Notes 1 to 5, further including:
a cylinder head communication passage configured to allow the inside of the cylinder head to communicate with an upstream side of the compressor in the engine intake passage; and
a filter disposed in the cylinder head communication passage.

Supplementary Note 7

The system according to Supplementary Note 6, wherein the hydrogen sensor is disposed downstream of the filter in the cylinder head communication passage.

### Supplementary Note 8

The system according to any one of Supplementary Notes 1 to 7, further including a pressure relief valve configured to release the air inside the crankcase before pressure inside the crankcase reaches a predetermined pressure or higher.

### Supplementary Note 9

A control method for a system including an engine operable with a fuel containing hydrogen,
the system including:
a crankcase and a cylinder head of the engine;
an engine intake passage through which air is suctioned into the engine;
a crankcase intake passage branching from the engine intake passage and through which the air is introduced into the crankcase;
a dilution air valve disposed in the crankcase intake passage and configured to open and close the crankcase intake passage;
a decompression valve disposed downstream of the dilution air valve in the crankcase intake passage;
a compressor disposed upstream of a branch portion at which the crankcase intake passage branches from the engine intake passage;
a hydrogen sensor configured to detect hydrogen concentration inside the crankcase; and
a communication path configured to allow an inside of the crankcase to communicate with an inside of the cylinder head,
the control method including:
acquiring the hydrogen concentration inside the crankcase;
determining whether or not the hydrogen concentration is a threshold value or higher;
opening the dilution air valve when it is determined that the hydrogen concentration is the threshold value or higher; and
closing the dilution air valve when it is determined that the hydrogen concentration is lower than the threshold value.

### Supplementary Note 10

The control method according to Supplementary Note 9, wherein the system further includes:
a cylinder head communication passage configured to allow the inside of the cylinder head to communicate with an upstream side of the compressor in the engine intake passage;
a cylinder head exhaust passage branching from the cylinder head communication passage and through which the air inside the cylinder head is discharged; and
a switching valve disposed at a branch portion at which the cylinder head exhaust passage branches from the cylinder head communication passage and configured to switch between a first path through which the cylinder head exhaust passage is exposed to the atmosphere and a second path through which the cylinder head communication passage connects to the upstream side of the compressor, and
the control method includes:
allowing the switching valve to switch to the second path when it is determined that the hydrogen concentration is the threshold value or higher; and
allowing the switching valve to switch to the first path when it is determined that the hydrogen concentration is lower than the threshold value.

According to the above aspect, hydrogen gas can be prevented from igniting inside the crankcase and deterioration in cost-effectiveness and reliability can be suppressed.

### REFERENCE SIGNS LIST

1 System, 2 Engine, 3 Control device, 12 Crankcase, 13 Cylinder head, 30 Engine intake passage, 32 Crankcase intake passage, 34 Branch portion at which crankcase intake passage branches from engine intake passage, 35 Communication path, 43 Compressor, 55 Dilution air valve, 56 Decompression valve, 60 Hydrogen sensor, 70 Cylinder head communication passage, 71 Filter, 201 System, 280 Air supply throttle, 281 First check valve, 282 Crankcase communication passage, 283 Second check valve, 301 System, 390 Cylinder head exhaust passage, 391 Branch portion at which cylinder head exhaust passage branches from cylinder head communication passage, 392 Switching valve, 401 System, V1 First path, V2 Second path

1. A system comprising an engine operable with a fuel containing hydrogen, the system comprising:
a crankcase and a cylinder head of the engine;
an engine intake passage through which air is suctioned into the engine;
a crankcase intake passage branching from the engine intake passage and through which the air is introduced into the crankcase;
a dilution air valve disposed in the crankcase intake passage and configured to open and close the crankcase intake passage;
a decompression valve disposed downstream of the dilution air valve in the crankcase intake passage;
a compressor disposed upstream of a branch portion at which the crankcase intake passage branches from the engine intake passage;
a hydrogen sensor configured to detect hydrogen concentration inside the crankcase;
a communication path configured to allow an inside of the crankcase to communicate with an inside of the cylinder head; and
a control device configured to control opening and closing of the dilution air valve based on the hydrogen concentration detected by the hydrogen sensor.

2. The system according to claim 1, wherein when the hydrogen concentration detected by the hydrogen sensor reaches a threshold value or higher, the control device performs control to open the dilution air valve to a predetermined degree or more.

3. The system according to claim 1, further comprising:
an intake throttle disposed downstream of the compressor and upstream of the branch portion in the engine intake passage;
a first check valve disposed downstream of the decompression valve in the crankcase intake passage and configured to allow only a flow of gas from the decompression valve toward the inside of the crankcase;
a crankcase communication passage branching from the crankcase intake passage at a portion between the dilution air valve and the decompression valve and communicating with the inside of the crankcase; and
a second check valve disposed in the crankcase communication passage and configured to allow only a flow of gas from the inside of the crankcase toward the crankcase intake passage.

4. The system according to claim 1, further comprising:
a cylinder head communication passage configured to allow the inside of the cylinder head to communicate with an upstream side of the compressor in the engine intake passage;
a cylinder head exhaust passage branching from the cylinder head communication passage and through which the air inside the cylinder head is discharged; and
a switching valve disposed at a branch portion at which the cylinder head exhaust passage branches from the cylinder head communication passage and configured to switch between a first path through which the cylinder head exhaust passage is exposed to the atmosphere and a second path through which the cylinder head communication passage connects to the upstream side of the compressor.

5. The system according to claim 4, wherein the control device is configured to control the switching valve to switch to the second path when the hydrogen concentration detected by the hydrogen sensor reaches a threshold value or higher.

6. The system according to claim 1, further comprising:
a cylinder head communication passage configured to allow the inside of the cylinder head to communicate with an upstream side of the compressor in the engine intake passage; and
a filter disposed in the cylinder head communication passage.

7. The system according to claim 6, wherein the hydrogen sensor is disposed downstream of the filter in the cylinder head communication passage.

8. The system according to claim 1, further comprising a pressure relief valve configured to release the air inside the crankcase before pressure inside the crankcase reaches a predetermined pressure or higher.

9. A control method for a system comprising an engine operable with a fuel containing hydrogen,
the system comprising:
a crankcase and a cylinder head of the engine;
an engine intake passage through which air is suctioned into the engine;
a crankcase intake passage branching from the engine intake passage and through which the air is introduced into the crankcase;
a dilution air valve disposed in the crankcase intake passage and configured to open and close the crankcase intake passage;
a decompression valve disposed downstream of the dilution air valve in the crankcase intake passage;
a compressor disposed upstream of a branch portion at which the crankcase intake passage branches from the engine intake passage;
a hydrogen sensor configured to detect hydrogen concentration inside the crankcase; and
a communication path configured to allow an inside of the crankcase to communicate with an inside of the cylinder head,
the control method comprising:
acquiring the hydrogen concentration inside the crankcase;
determining whether or not the hydrogen concentration is a threshold value or higher;
opening the dilution air valve when it is determined that the hydrogen concentration is the threshold value or higher; and
closing the dilution air valve when it is determined that the hydrogen concentration is lower than the threshold value.

10. The control method according to claim 9, wherein the system further comprises:
a cylinder head communication passage configured to allow the inside of the cylinder head to communicate with an upstream side of the compressor in the engine intake passage;
a cylinder head exhaust passage branching from the cylinder head communication passage and through which the air inside the cylinder head is discharged; and
a switching valve disposed at a branch portion at which the cylinder head exhaust passage branches from the cylinder head communication passage and configured to switch between a first path through which the cylinder head exhaust passage is exposed to the atmosphere and a second path through which the cylinder head communication passage connects to the upstream side of the compressor, and
the control method comprises:
allowing the switching valve to switch to the second path when it is determined that the hydrogen concentration is the threshold value or higher; and
allowing the switching valve to switch to the first path when it is determined that the hydrogen concentration is lower than the threshold value.

11. The system according to claim 2, further comprising:
an intake throttle disposed downstream of the compressor and upstream of the branch portion in the engine intake passage;
a first check valve disposed downstream of the decompression valve in the crankcase intake passage and configured to allow only a flow of gas from the decompression valve toward the inside of the crankcase;
a crankcase communication passage branching from the crankcase intake passage at a portion between the dilution air valve and the decompression valve and communicating with the inside of the crankcase; and
a second check valve disposed in the crankcase communication passage and configured to allow only a flow of gas from the inside of the crankcase toward the crankcase intake passage.

12. The system according to claim 2, further comprising:
a cylinder head communication passage configured to allow the inside of the cylinder head to communicate with an upstream side of the compressor in the engine intake passage;
a cylinder head exhaust passage branching from the cylinder head communication passage and through which the air inside the cylinder head is discharged; and
a switching valve disposed at a branch portion at which the cylinder head exhaust passage branches from the cylinder head communication passage and configured to switch between a first path through which the cylinder head exhaust passage is exposed to the atmosphere and a second path through which the cylinder head communication passage connects to the upstream side of the compressor.

13. The system according to claim 12, wherein the control device is configured to control the switching valve to switch to the second path when the hydrogen concentration detected by the hydrogen sensor reaches a threshold value or higher.

14. The system according to claim 2, further comprising:
a cylinder head communication passage configured to allow the inside of the cylinder head to communicate with an upstream side of the compressor in the engine intake passage; and
a filter disposed in the cylinder head communication passage.

15. The system according to claim 14, wherein the hydrogen sensor is disposed downstream of the filter in the cylinder head communication passage.

16. The system according to claim 2, further comprising a pressure relief valve configured to release the air inside the crankcase before pressure inside the crankcase reaches a predetermined pressure or higher.
